(19) United States
(12) Patent Application Publication
(10) Pub. No.: US 2026/0223811 A1
(43) Pub. Date: Aug. 6, 2026

(54) MODULAR ENCLOSED ENVIRONMENT FOR REPTILES

(71) Applicant: Traci Shuler, Arvada, CO (US)

(72) Inventor: Traci Shuler, Arvada, CO (US)

(21) Appl. No.: 19/150,947

(22) PCT Filed: Nov. 21, 2023
(86) PCT No.: PCT/US23/80629

§ 371 Date: Jul. 25, 2025

Related U.S. Application Data
(60) Provisional application No. 63/443,285, filed on Feb. 3, 2023.

(51) Int. Cl. A01K 1/03; A01K 1/00; A01K 63/00

(52) U.S. Cl. CPC A01K 1/03; A01K 1/0082; A01K 63/003

(57) ABSTRACT

A customizable reptile cage is provided, incorporating an interchangeable lid, center body, and base. In various examples, the reptile cage is adaptable to a variety of environmental needs of the reptiles living within and human needs corresponding to the surrounding exterior area within which the reptile cage is placed. A further aspect of the reptile cage is the interchangeability of several of the key parts to enable the creation of a more optimal environment for the species of reptile intended for placement therein.

### FIELD OF THE INVENTION

The present invention relates to environments for pets, and more specifically enclosed environments created for pet reptiles.

### BACKGROUND OF THE INVENTION

Many pet owners prefer reptiles. However, reptiles have specialized needs that are not encountered by other common pets such as dogs and cats. Often, reptiles require specialized, climate-controlled living spaces that can accommodate specialized lighting, feeding, and specialized flooring materials. As such, a specialized enclosed environment, often a cage, is needed to provide an adequate environment for reptiles to flourish.

Yet even among reptiles themselves there remain many variations. An environment for a bearded dragon lizard, for example, requires mimicking its natural environment exposed to the full heat of the sun by providing a very warm basking area with a heat lamp over a large portion of its living space. Other reptiles, such as garter snakes and skinks that naturally live in cooler regions require a much different living space that often facilitates extended periods of dormancy (mimicking a cooler winter). As such, there presently exists no single configuration of an enclosed reptile living environment, that can address all of the different variations of preferable reptile living environments.

Relatedly, the specialized needs of the pet reptile owners and more broadly reptile owners reflect differing needs for the living spaces of the reptiles. For example, reptile breeders have different environment requirement (often to accommodate multiple breeding reptiles) than the owner of a single or few expensive exotic reptiles. People who live in small spaces within high rise apartment buildings often have different requirements for pet reptile environments than people who live in expansive standalone homes. While the “one size fits all” approach to providing a pet reptile environment continues to prevail, there remains a need for a more customizable enclosed reptile living environment to address specific requirements of human owners and their pet reptiles.

Another challenge associated with optimizing the living environments for pet reptiles is the need to adapt each environment to exist adequately within human living spaces. Enclosed reptile living environments, for example, are often big and heavy. Often, standard sized cages and aquariums are adapted to fit within human living spaces. Yet, the standard sizing does not provide for customization of different species of reptiles and their unique environment requirements. Moreover, the challenges to human owners associated with carrying a heavy standard sized tank for cleaning are significant to many human owners.

Therefore it remains necessary to have a more customizable reptile living environment able to exist within a human living space that allows the owner of a pet reptile to optimize the pet reptile's living environment and needs, while balancing the constraints of placing such a living environment within a human living space.

### SUMMARY OF THE INVENTION

The preferred embodiment provides a modular enclosure to provide an environment for a reptile to live. The preferred embodiment comprises a lid, a center body, and a base, such that when assembled provides a substantially cylindrical shape with an ovular cross section with an enclosed interior space offering an environment for reptiles. In association with the preferred embodiment, the lid is configured to rest upon the center body, and the center body is configured to securely rest upon the base. In various embodiments, aspects of the enclosure, and in particular the lid and the center body, are interchangeable to provide for particularized environments optimized for different animals placed within. In various embodiments, aspects of the enclosure are configured with apertures to allow for the placement of accessories such as lamps and foggers, and also to allow fluid contents placed within all or part of the enclosure to drain out.

### BRIEF DESCRIPTION OF FIGURES

FIG. 1 depicts an exemplary presentation of the enclosure in its assembled state.

FIG. 2 depicts an exploded view of a lid, center body, and base associated with an embodiment of the invention.

FIG. 3a depicts the lid in fully vented configuration in an embodiment.

FIG. 3b depicts the lid in partially vented configuration in an embodiment.

FIG. 3c. depicts the lid in fully enclosed configuration in an embodiment.

FIG. 4 depicts an exemplary use of an embodiment designed to operate with an attached fogger.

FIG. 5 depicts an embodiment in fully enclosed configuration and further comprising brackets and a water tight plug.

FIG. 6 depicts the connective aspects comprising magnets embedded within the center body and magnets embedded within the base in an exemplary embodiment.

FIG. 7 depicts connective aspects of the center body and connective aspects of the base in an exemplary embodiment.

FIG. 8a depicts an embodiment of the base comprising a water tight plug secured within a drain.

FIG. 8b depicts an embodiment of the base comprising a drain with the corresponding water tight plug removed.

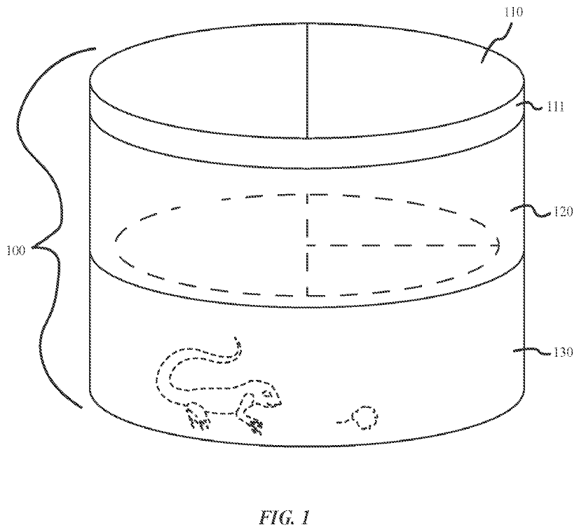

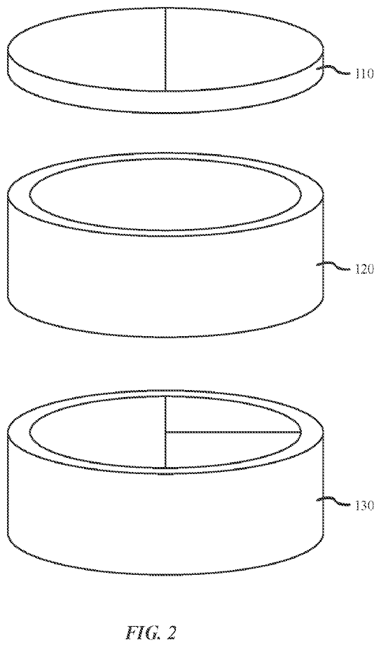

### DETAILED DESCRIPTION OF THE INVENTION

The present invention is directed to a reptile cage 100 to create an environment for a pet reptile. It is an aspect of the invention to provide an enclosed or partially enclosed reptile living environment, that among other benefits allows for ease of cleaning the environment provided therein. It is also an aspect of the invention to allow for customization to adapt a reptile cage 100 to the specialized needs of the reptile Base 130d upon the specialized needs of the pet owner and the pet reptile. In an exemplary embodiment, the animal's living space primarily comprises the areas superior to or within the materials placed within the base. As such, in association with various embodiments, the animal's living space primarily comprises the superior aspects of the interior volume of the base. In association with various embodiments, the height of the base may vary to facilitate the placement of varying levels of substrate or fluid, such that the animal within may enjoy one of various configurations of a living area particularly suitable for the animal. As such, the interior volume of the base is partially filled with substrate and/or water in association with the intended usage. Thus, in an embodiment it is contemplated that the animal will live primarily in a living environment within the volume above the substrate and/or water placed within the base as opposed to the inferior plane of the base itself.

In the preferred embodiment of the invention, the reptile cage 100 is provided as three individual pieces designed to interact with each other, comprising a lid 110, center body 120, and base 130. In various embodiments of the invention, the dimensions of each piece are adaptable to meet specialized needs of the human owner of the pet reptile and the pet reptile.

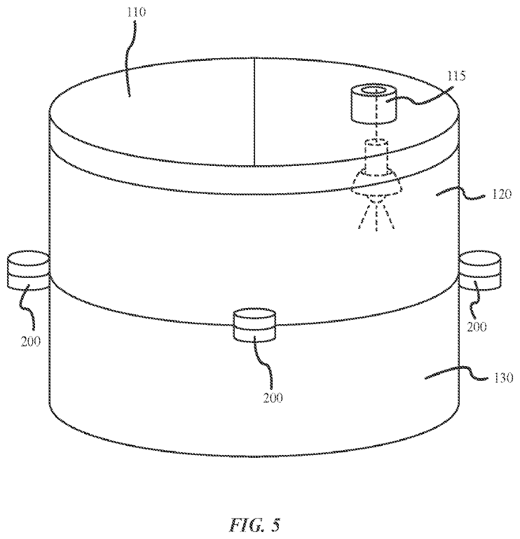

In various embodiments, the reptile cage 100 comprises a plurality of connective mechanisms designed to hold the components of the reptile cage 100 together. In various embodiments, the connective mechanisms comprise various brackets 200 configured to hold the aspects of the reptile cage 100 together. In an exemplary embodiment, the brackets 200 comprise magnets of corresponding shapes, such that when placed in interaction with each other they secure together. In the preferred embodiments, the brackets 200 comprise magnets, optionally arranged as depicted in FIG. 5. In the preferred embodiment, the lid 110 consists primarily of high heat epoxy-coated aluminum. The present inventor has recognized that in association with the teachings of embodiments of the invention, the various components comprise high heat epoxy-coated aluminum, which provides the advantages of rust resistance and weight minimization.

The preferred embodiment of the reptile cage 100 comprises a lid 110. In various embodiments, the lid 110 is substantially oval-shaped. The lid 110 is shaped to correspond and fit snugly to the upper aspect of the center body 120. In an embodiment, the lid 110 further comprises a plurality of brackets 200 comprising magnets. Each of the plurality of magnets attached to the lid 110 comprise metal and are welded to the lid 110 in the preferred embodiment. In various embodiments, the metal intended for use within each of the magnets and within the other aspects of the reptile cage 100 comprises a heat-resistant, animal-safe coating. In the preferred embodiment, the coating consists of high heat epoxy. In association with various embodiments, the high heat epoxy is applied to components via powder coating or a spray-on coat. In an exemplary configuration, the lid 110 comprises full venting with a single Accessory aperture 115 corresponding to the dimensions of a filter. In association with various embodiments of the invention, the filter size corresponds to the needs of the animal housed within the reptile cage 100. In an embodiment, the accessory aperture 115 corresponds to the dimensions necessary to allow a fogger to fit snugly within.

In the preferred embodiment, the locations of each of the plurality of magnets attached to the lid 110 correspond to the location of each of the plurality of magnet receptacles attached to the center body 120 when the lid 110 is placed upon the uppermost aspect of the center body 120 during an intended method of use.

In the preferred embodiment, the lid 110 further comprises a lid lip 119. To provide the lid lip 119, during the preferred method of manufacture, the lid 110 is bent along the path corresponding to the shape of upper-most aspect of the center body 120. In such way, the lid 110 can slide 110 over the upper-most aspect of the center body 120 with the lid lip 111 extending downward over a slight outer aspect of the center body 120

It is an aspect of the invention for the lid 110 to be interchangeable with other configurations of the lid 110. In such example, the lid 110 may be replaced with an alternative lid 110 configuration dependent upon the specific intended use.

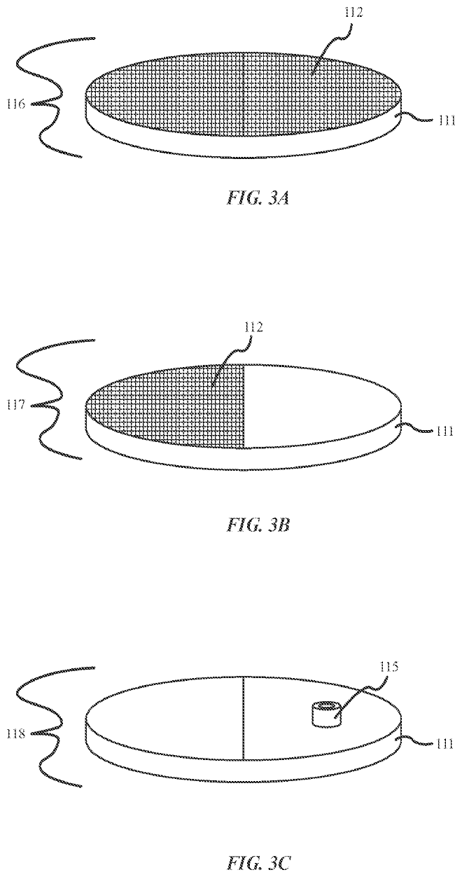

In one example, the lid 110 comprises full venting, as depicted in FIG. 3a. In association with the preferred embodiment, the lid 110 in its fully vented configuration 116 comprises an epoxy-coated aluminum frame, and further comprises one or more epoxy-coated stainless steel screen(s) 112 overlaying one or more aperture(s) comprising the majority of the area located within the area inside the circumference of the lid 110. The present inventor has recognized the advantage of such exemplary embodiment in association with reptiles that do not require high humidity, as the external atmosphere exposure facilitated in association with the fully vented configuration 116 allows for normalization with the environment surrounding the reptile cage 100.

In another example, the lid 110 comprises partial venting, as depicted in FIG. 3b. In association with such embodiment, in such partial venting configuration 117, approximately half of the surface area comprising the interior aspects of the circumference of the lid 110 would comprise of solid aluminum, optionally epoxy-coated aluminum, and approximately half of the area would comprise one or more venting aperture(s), optionally further comprising epoxy-coated stainless steel screen 112 overlaying each aperture as depicted in FIG. 3b. As such configuration would primarily comprise approximately half aluminum and half screen 112, the present inventor recognizes the related advantages of the capability for lights to be used, and for easier retention of a higher level of humidity within the environment inside the reptile cage 100.

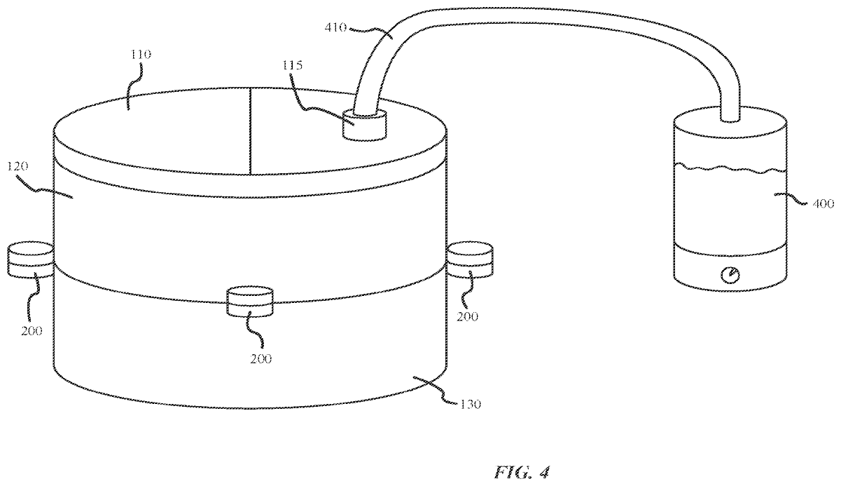

In yet another example depicted in FIG. 3c, the lid 110 is substantially fully enclosed and thus comprises only minimal venting and/or a vented opening for a heat and/or a basking light. Optionally, the lid 110 in its substantially fully enclosed configuration 118 may still comprise an accessory aperture 115 to allow for the placement of an accessory (for example, a light) through the lid 110, though the accessory may be sealed in place to prevent atmospheric exposure to the environment external to the cage. In association with such substantially fully enclosed configuration 118, the present inventor recognizes the advantage that the internal environment of the reptile cage 100 is more easily controllable in association with specified use cases. For example, with the lid 110 in the substantially fully enclosed configuration, the reptile cage 100 may facilitate an interior environment primarily suitable for water reptiles, or reptiles who are ill and need “fogging,” as depicted in FIG. 4. The present inventor has also recognized the advantages associated with the substantially fully enclosed configuration in that it allows for the maintenance of high humidity, in association with humidity-generating accessories as known in the art, to facilitate treatment for reptiles placed inside that have afflictions, such afflictions for example including but not limited to like kidney stones.

In various embodiments, the lid 110 further comprises at least one accessory aperture 115. In various embodiments, the lid 110 comprises a plurality of accessory apertures 115. It is contemplated by the inventor that in an example, an accessory aperture 115 of the lid 110 may correspond in circumference to the outer circumference of a nozzle or hose 410, for example the nozzle or hose of a fogger 400, for example. In an exemplary embodiment, an accessory aperture 115 of the Lid 110 has an aperture diameter of 1¼″, corresponding to a common outer diameter associated with the tube 410 of a fogger 400 to be placed within the accessory aperture 115 in an intended use. In another example, an accessory aperture 115 corresponds to the circumference of a single basking lamp. In an exemplary embodiment, an accessory aperture 115 of the lid 110 has an aperture diameter of approximately 5-6″ corresponding to the outer diameter of commonly used single basking lights to be placed within the accessory aperture 115 in an intended use. In yet another embodiment, an accessory aperture 115 of the lid 110 has an aperture diameter of approximately 11-12″ corresponding to the outer diameter of commonly used double basking light to be placed within the accessory aperture 115 in an intended use. In another example, there are two accessory apertures 115 intended for a double basking lamp configuration, each of the accessory apertures 115 corresponding in size to the outer circumference of a basking lamp intended to be placed therein. In another example, an accessory aperture 115 corresponds in size to the outer dimensions of a filter. In an embodiment, an accessory aperture 115 extends from the upper facing aspect of the lid 110 to the lid lip 111 to facilitate the entire width of a filter to be placed within the accessory aperture 115 in association with an intended use.

The preferred embodiment of the reptile cage 100 comprises a center body 120. In various embodiments, the center body 120 comprises an oval cross section. In the preferred embodiment, the center body 120 is comprised of acrylic. In association with the preferred embodiment, the acrylic intended for use within the center body 120 and other aspects of the reptile cage 100 consists of heat-resistant, animal-safe acrylic. In an embodiment, the acrylic comprises Lexan 9034. In an alternative embodiment, the acrylic comprises Lexan abrasion resistant MR10. The present inventor has recognized that the utilization of acrylic specifically allows for a lightweight construction that enables the reptile cage 100 to be easily moved and cleaned. The present inventor has recognized that the utilization of acrylic in association with embodiments of the invention makes the reptile cage 100 ideal for breeding. In association with an embodiment, the present inventor has recognized the benefit associated with the selectability of color shading of the acrylic optionally corresponding to shades to facilitate breeding or the other specialized care of reptiles placed within the reptile cage 100. The present inventor has recognized that the utilization of acrylic in association with embodiments of the invention is advantageous in that it has heat-resistant properties particularly useful in association with embodiments comprising a heat lamp. In an embodiment, the center body 120 is substantially oval-shaped from a top-down view. In an embodiment, the center body 120 further comprises a protrusion of dimensions to correspond with a center groove of the base 130. In an embodiment, the protrusion extends ½ inch from the main aspect of the center body 120. In various embodiments the protrusion functions to allow for the lip to securely connect the base 130 to the center body 120. In an alternative embodiment, the incorporation of corresponding magnets and/or brackets 200 into the base 130 and the center body 120 augment or replace the connective functionality associated with the protrusion to securely attach the center body 120 to the base 130. The present inventor has observed that the specific dimension variations contemplated address the specialized needs for one or more species of reptiles. In various embodiments, the Center Body 120 is clear or tinted. In an exemplary embodiment, the center body 120 is 12 inches tall. In various embodiments, the diameter of the center body 120 varies to facilitate the volume of interior space appropriate for the habitat associated with the specified needs of various reptiles.

In various embodiments, the center body 120 is interchangeable. As such, in various embodiments, the center body 120 comprises different height variations corresponding to the environmental needs of the reptile to be placed therein. The present inventor has recognized that the height of the center body 120 should vary in association with configurations associated with differing intended uses. In an exemplary embodiment associated with a ground dwelling reptile, the center body 120 is approximately 12 inches in height. However, in an alternative embodiment of the center body 120 intended for use in association with a climbing reptile, the center body 120 should be approximately 36 inches in height. It is a teaching associated with the preferred embodiment for the center body 120 to be exchangeable to accommodate the specific reptile placed within the reptile cage 100. In the preferred embodiment, the cross-sectional shape of the center body 120 remains consistent among each interchangeable center body 120 variation. As such, the present inventor has recognized the advantage in the context of the invention for a different center body 120 variation to be utilized in association with the same base 130 and the same lid 110 as may be used with an alternative center body 120 variation.

The center body 120 in an embodiment further comprises one or more magnet receptacles, optionally integrated within the brackets 200 or replacing the location of the brackets 200. In the preferred embodiment, the center body 120 comprises from 2-4 brackets 200, and or magnets and magnet receptacles, near the upper aspect of the center body 120 approximately equally spaced from one another along the exterior aspect of the center body 120, and further comprises from 2-4 brackets 200, and or magnets and magnet receptacles near the lower aspects of the center body 120 approximately equally spaced from one another along the exterior aspect of the center body 120. In the preferred embodiment, the brackets 200 are attached to the acrylic of the center body 120 by screws and/or glue. In various embodiments, the placement locations associated with the brackets 200, optionally comprising magnets or magnet receptacles, upon the center body 120 correspond to the brackets 200, optionally comprising magnets or magnet receptacles, upon other aspects of the reptile cage 100 to facilitate the secure attachment among and between the components of the reptile cage 100 to hold them together securely.

In an alternative embodiment, the center body 120 further comprises one or more magnets. In an embodiment, each of the brackets 200 comprises a magnet corresponding to an opposing magnet that generates force to retain each magnet together. In the preferred embodiment, the center body 120 comprises from 2-4 magnets near the upper aspect of the center body 120 approximately equally spaced from one another along the exterior aspect of the center body 120, and further comprises 2-4 magnets near the lower aspects of the center body 120 approximately equally spaced from one another along the exterior aspect of the center body 120, optionally housed within the brackets 200 as depicted in FIG. 5. In the preferred embodiment, the magnets are attached to the acrylic of the center body 120 by screws and/or glue. In various embodiments, the placement locations associated with the magnets upon the center body 120 correspond to the placement of other magnets upon other aspects of the reptile cage 100 to facilitate the secure attachment among the components of the reptile cage 100 together.

The preferred embodiment of the reptile cage 100 comprises a base 130. In an embodiment, the base 130 is formed from plastic. In various embodiments, the connective aspects of the center body (i.e. the magnets) and the corresponding connective aspects of the base (i.e. the magnets) are arranged in such a way, and the lower aspects of the center body and the upper aspects of the base are of dimensions such that when the center body is placed upon the base in an orientation such that the connective aspects of the base and the connective aspects of the center body interact that a seal or substantial seal is created, thereby providing an airtight or substantially airtight connection among the center body and the base and thereby enclosing the volume within the center body and the base. In an embodiment, the base 130 incorporates a center groove corresponding to the center protrusion of the Center Body 120. In an exemplary configuration, the base 130 is 24 inches in height, with no dividers and a removable screw-in plug. In an embodiment, the screw-in plug comprises a standard threaded 1¼ inch plug with corresponding threading within the Base 130.

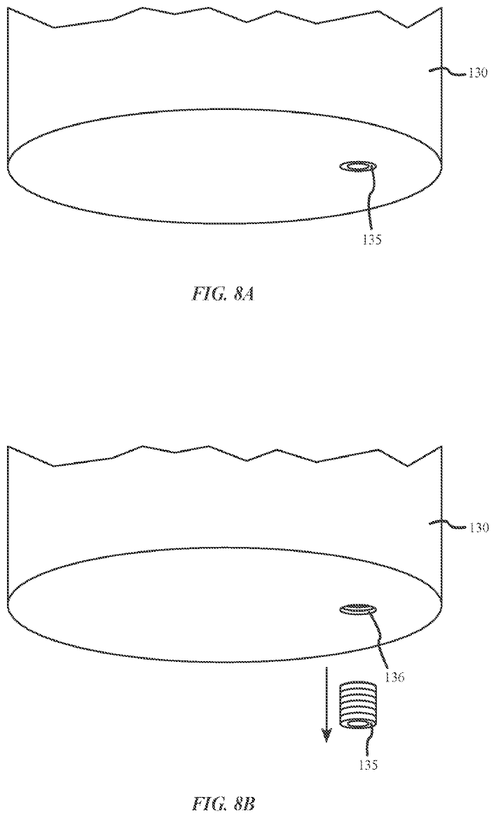

In an embodiment, the base 130 is watertight. In such example, the base 130 is intended to hold water. The base 130 may further comprise one or more removable water tight plug(s) 135, as depicted in FIG. 8a, corresponding in sizing to fasten within a drain 136. The present inventor has recognized that during cleaning, or replacement of the water held within the base 130, it is advantageous to remove each water tight plug 135, as depicted in FIG. 8b, to allow for the volume of contents held within the base 130 to drain out. As such, the one or more drains 136 corresponding to the locations for placement within the base 130 of the one or more water tight plugs may further comprise a water tight seal. In the preferred embodiments, the base 130 further comprises a rubber insert to facilitate the water tight seal of the base 130. In association with the preferred embodiment, each of the drains 136 will be located within the inferior most aspect of the base. In an embodiment, each of the drains 136 will be covered by the rubber insert.

In an embodiment, the base 130 further comprises one or more dividers 137, though in various embodiments, the base 130 does not comprise any dividers. In various embodiments the one or more dividers 137 consist of alternate dimensions corresponding to fit within the dimensions of the base 130, but while providing a barrier separating volumes within the base 130. In an embodiment, the base 130 is formed such that the one or more dividers 137 form part of the main body of the base 130, such that each of the sections of the base 130 formed by the inclusion of each of the dividers 137 do not allow for the materials placed within to make contact with the interior volume of the other sections. In an alternative embodiment, each of the dividers 137 may be placed within and removed from the interior volume of the base 130. In an exemplary embodiment, the placeable and removable configuration, the contours of each of the dividers 137 match the dimensions of the interior aspects of the body of the base 130, and optionally other aspects of the divider 137 or other dividers 137, such that each of the dividers form a tight seal therefore separating the interior volume of each section within the base 130 created by the one or more dividers 137 from any other section within the base 130 created by the one or more dividers 137. In various embodiments, the dividers 137 may be placed to facilitate the separate environments to provide for the environmental needs of the reptiles placed within the sectioned volume of the base 130.

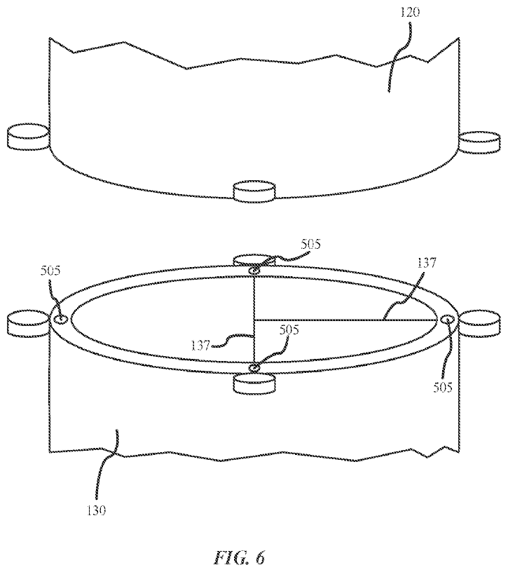

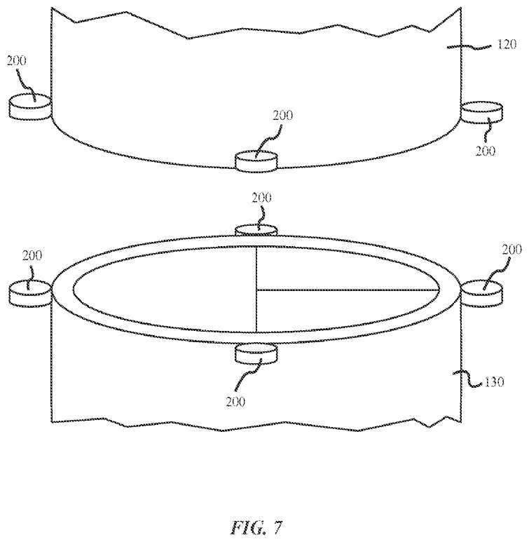

In the preferred embodiment, the base 130 further incorporates a plurality of magnets embedded within the body of the base 505, as depicted in FIG. 6. In such embodiment, the placement of the magnets embedded within the base 130 corresponds to the placement location of the magnets embedded within the center body. When placed together, the attractive force of the magnets embedded within the base 505 and the corresponding magnets embedded within the center body 120 facilitate the secure attachment of the center body 120 to the base 130. In an alternative embodiment, the base 130 further incorporates a plurality of magnets. The plurality of magnets are attached to the base 130 by glue and/or screws. In the preferred embodiment, the plurality of magnets are attached to the base 130 in an orientation and at locations such that, when the center body 120 is slid 110 into the base 130, the magnets interact with the magnet receptacles in a manner to hold the center body 120 and the case 130 together. In various embodiments, the diameter of the center body is slightly less than the diameter of the base 130 and/or the lid 110 to allow for the center body 130 to slide within aspects of the base 130 and/or the lid 110. In the preferred embodiment, the lid 110 further comprises a plurality of magnets. In the preferred embodiment, each of the plurality of magnets is constructed of metal. In the preferred embodiment, the lid 110 is placed over the center body 120 in such a manner that the each of the plurality of magnets attached to the lid 110 correspond to the locations of each of a plurality of magnet receptacles attached to the center body 120 such that the lid 110 can securely attach to the center body 120 via the interaction of the plurality of magnets attached to the lid 110 and the corresponding plurality of magnet receptacles attached to the center body 120.

During a preferred method of use, the reptile cage 100 is utilize in accordance with the following steps. In various embodiments, the steps are re-ordered or omitted based upon alternative intended uses.

In association with an intended method of use, a selecting the appropriate lid 110 step is performed. During such step, a person performing the step considers whether one or more Accessory apertures 115 are necessary for placement of accessories (i.e. basking lamps, filters) to accommodate the needs of a reptile placed therein. Separately, a person performing the step considers whether or not a specialized level of venting is necessary. Accordingly, a configuration of lid 110 with the desired characteristics is selected during this step.

In association with an intended method of use, a choosing the appropriate center body 120 step is performed. In various embodiments of the invention, a center body 120 of a differing dimension or configuration may be selected based upon various requirements associated with the environment to be enclosed. As described herein, one of several alternate configurations of a center body 120 may be more appropriate than other alternate configuration for a particular reptile or alternative use. Accordingly, a configuration of center body 120 with the desired characteristics is selected during this step.

In association with an intended method of use, a placing the selected center body 120 within the base 130 step is performed. In association with this step, the person assembling the reptile cage 100 may align the protrusion of the center body 120 with the groove of the base 130. In various embodiments, the protrusion of the center body 120 and the groove of the base 130 are configured to prevent the center body 120 from sliding downward into the base, and to prevent the center body 120 from slidably rotating within the base 130, as will be appreciated by skilled artisans. It is contemplated that so long as the protrusion of the center body 130 and the corresponding groove of the base 130 are of dimensions to allow the protrusion of the center body 120 to fit within the groove of the base 130, then the protrusion of the center body 120 may be placed near the inferior aspect of the center body 120 and the corresponding groove of the base 130 may be placed near any superior aspect of the base 130. Further in association with this step, the person assembling the reptile cage 100 may engage the magnets with the associated magnet receptacles located among the center body 120 and the case 130 to secure the center body 120 and the base 130 together.

In association with an intended method of use associated with a configuration of the base 130 that does not incorporate pre-formed dividers 137 within the main body of the base 130 as described elsewhere herein, optionally, an inserting the one or more dividers 137 within the base 130 step is performed. In association with various configurations, it is an aspect of the invention to allow for configurations of the dividers 137 corresponding to intended habitats for objects (such as reptiles, or other flora and fauna) placed within the reptile cage 100. As such, in association with this step, the person assembling the reptile cage 100 may choose one or more dividers 137 based upon the needs of the objects to be placed therein, or otherwise elect not to place any dividers 137 within the cage. In an alternative configuration of the base 130 comprising dividers forming a portion of the main portion of the base 130, the present inventor has recognized that such an embodiment is advantageous as it does not require the placement or configuration of one or more dividers 137 to form specific subdivided living spaces for animals placed within, though disadvantageously lacks customizability if particular configurations that do not correspond with a pre-defined divider 137 do not match the requirements of a particular animal placed inside the base 130.

In association with an intended method of use, a relocating the objects intended to be inserted into the cage step is performed. During such step, the objects (including reptiles, or other flora and fauna) are physically placed within the reptile cage 100 by the person assembling the cage. It is a teaching of an embodiment of the invention to provide for ideal conditions for plant growth similar to the terrarium, regardless of whether a reptile is placed therein. The present inventor recognizes that in an intended method of use, it is desirable to provide an environment to allow for specialized plant growth, including in association with providing a plant-laden environment for one or more reptiles. As such, elements such as the lid 110, attachments for fitment within the attachment apertures, center body 120, and dividers 137 are chosen to enable the optimal plant growth conditions within the reptile cage 100.

In association with an intended method of use, an attaching the lid 110 to the center body 120 step is performed. During such step, the person assembling the reptile cage 100 may align the brackets 200, optionally comprising magnets and magnet receptacles, located among the lid 110 and the Center Body 120 such that they may be engaged to secure the lid 110 and the center body 120 together. In an intended method of use, the lid lip 111 slides over the exterior aspect of the center body 120 to provide for more secure integration of the lid 110 and the center body 120.

In association with an intended method of use, optionally, the inserting the lid attachments within the accessory apertures 115 step is performed. During this step, the lid attachments intended for use and fitment within the accessory apertures 115 of the lid 110 chosen by the person assembling the reptile cage 100 are placed and optionally secured within the accessory apertures 115 of the lid 110. Further in association with this step, any configurable venting or filters are modified to the desire of the person assembling the reptile cage 100 together.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-10. (canceled)

11. A modular enclosure system for providing an environment for reptiles, comprising:
a lid formed of high heat epoxy-coated aluminum and having lower aspects with dimensions corresponding to upper aspects of a center body, wherein the lid is selectable from a fully vented configuration comprising epoxy-coated stainless steel screens, a partially vented configuration comprising approximately half solid aluminum and half epoxy-coated stainless steel screens, and a substantially fully enclosed configuration;
the center body comprising heat-resistant acrylic selected from or with substantially similar characteristics to Lexan 9034 or Lexan abrasion resistant MR10, the center body having a substantially cylindrical shape with an ovular cross section and being interchangeable with center bodies of differing heights to accommodate needs of different reptile species, wherein upper aspects of the center body are configured to receive the lid of corresponding dimensions, and lower aspects of the center body include a protrusion extending from a main aspect of the center body;
a base comprising plastic and having a center groove corresponding to the protrusion of the center body, wherein the center body is configured to be securely placed upon the base with the protrusion fitting within the center groove to substantially seal an interior volume enclosed by the center body and the base;
a plurality of brackets comprising magnets, wherein the lid and the center body each comprise brackets with magnets positioned to secure the lid upon the center body, and wherein the center body and the base each comprise brackets with magnets positioned to secure the center body upon the base; and
wherein the modular enclosure system provides interchangeable components to facilitate customized environments for different reptile species.

12. The modular enclosure system of claim 11, wherein the lid further comprises at least one accessory aperture having a diameter selected from 1¼ inches for fogger tube placement, approximately 5-6 inches for single basking lamp placement, or approximately 11-12 inches for double basking lamp placement.

13. The modular enclosure system of claim 11, wherein the center body is interchangeable between a height of approximately 12 inches for ground dwelling reptiles and a height of approximately 36 inches for climbing reptiles, while maintaining consistent cross-sectional shape compatibility with the same base and lid.

14. The modular enclosure system of claim 11, wherein the center body further comprises color shading of the heat-resistant acrylic to facilitate breeding or specialized care of reptiles.

15. The modular enclosure system of claim 11, wherein the base further comprises a drain positioned at a lowest aspect of the base and a water tight plug removably secured within the drain.

16. The modular enclosure system of claim 11, wherein the base further comprises one or more removable dividers configured to create separate environmental sections within the base.

17. The modular enclosure system of claim 11, wherein the brackets comprise 2-4magnets positioned near upper aspects of the center body and 2-4 magnets positioned near lower aspects of the center body, with corresponding magnet receptacles on the lid and base respectively.

18. A method of configuring the modular enclosure system of claim 11 for different reptile species, comprising:
selecting a lid configuration from the fully vented, partially vented, or substantially fully enclosed configuration based on humidity requirements of a target reptile species;
choosing a center body height from available interchangeable center bodies based on whether the target reptile species is ground dwelling or climbing;
placing the chosen center body upon the base with the protrusion aligned with the center groove; and
securing the lid upon the center body using the magnetic bracket system.
